(19) United States
(12) Patent Application Publication
(10) Pub. No.: US 2024/0417011 A1
(43) Pub. Date: Dec. 19, 2024

(54) SEAT SUSPENSION SYSTEM FOR LIGHTWEIGHT VEHICLE

(71) Applicant: Arctic Cat Inc., Thief River Falls, MN (US)

(72) Inventors: Brent Gilge, Bemidji, MN (US); Charles Simenson, Thief River Falls, MN (US); Chris Evans, Warren, MN (US)

(21) Appl. No.: 18/437,807

(22) Filed: Feb. 9, 2024

Related U.S. Application Data
(60) Provisional application No. 63/508,296, filed on Jun. 15, 2023.

(51) Int. Cl. B62J 1/02; B62K 5/01

(52) U.S. Cl. CPC B62J 1/02; B62K 5/01

(57) ABSTRACT

A seat suspension system for a seat of a lightweight vehicle, wherein the system comprises a seat frame to which a seat can be connected, one or more of seat frame mounting bracket mounted to a chassis of the vehicle; one or more mounting feet extending from a front portion of the seat frame and pivotally connectable to the one or more seat frame mounting bracket; a damping assembly mounting bracket mounted to a rear cross member of the seat frame; and a damping device assembly mounted between the chassis of the vehicle and the damping assembly mounting bracket, the damping device assembly structured and operable to dampen the transfer of movement from the chassis of the vehicle to the seat frame.

### CROSS-REFERENCE TO RELATED APPLICATIONS

This application claims the benefit of U.S. Provisional Application No. 63/508,296, filed on Jun. 15, 2023. The disclosure of the above application is incorporated herein by reference in its/their entirety.

### FIELD

The present teachings relate to lightweight vehicles having seat assemblies, and more particularly to a lightweight vehicle seat assembly having a unique seat suspension system.

### BACKGROUND

The statements in this section merely provide background information related to the present disclosure and may not constitute prior art.

Various known lightweight vehicles, e.g., power sport vehicles, off-road vehicles and other lightweight vehicles, including include one or more seat that is directly fixed or connected to a chassis of the respective vehicle. In such instances the impact forces, shock and vibration encountered by the vehicle, particularly the vehicle chassis, as the vehicle traverses rough, bumpy, undulating, uneven or otherwise rugged terrain is transferred directly to the one or more seat. Moreover, the impact forces, shock and vibration are in turn transferred to a passenger and/or operator of the vehicle, thereby roughly jostling the passenger and/or operator making for an unpleasant and uncomfortable ride. In many instances such impact forces, shock and vibration incurred by the passenger and/or operator causes the passenger and/or operator to involuntarily lose contact with their seat and propels the passenger and/or operator forward, back and/or side-to-side, thereby providing a rough and undesirable ride.

### SUMMARY

In various embodiments, the present disclosure provides a seat suspension system for a seat of a lightweight vehicle, wherein the system comprises a seat frame to which a seat can be connected, one or more of seat frame mounting bracket mounted to a chassis of the vehicle; one or more mounting feet extending from a front portion of the seat frame and pivotally connectable to the one or more seat frame mounting bracket; a damping assembly mounting bracket mounted to a rear cross member of the seat frame; and a damping device assembly mounted between the chassis of the vehicle and the damping assembly mounting bracket, the damping device assembly structured and operable to dampen the transfer of movement from the chassis of the vehicle to the seat frame.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### DRAWINGS

The drawings described herein are for illustration purposes only and are not intended to limit the scope of the present teachings in any way.

FIG. 1A is an exemplary illustration of a lightweight vehicle having a seat suspension system, in accordance with various embodiments of the present disclosure.

FIG. 1B is an exploded view of the seat suspension system shown in FIG. 1A, in accordance with various embodiments of the present disclosure.

FIG. 2A is an exemplary exploded view of the seat suspension system shown in FIGS. 1A and 1B, in accordance with various embodiments of the present disclosure.

FIG. 2B is an exemplary side view of the seat suspension system shown in FIG. 2A mounted to a lightweight vehicle chassis and having a seat attached thereto, wherein seat suspension system is configured in a compressed disposition, in accordance with various embodiments of the present disclosure.

FIG. 2C is an exemplary side view of the seat suspension system shown in FIG. 2A, wherein a portion of the chassis has been removed to more clearly illustrate the seat suspension system, and wherein seat suspension system is configured in a neutral disposition, in accordance with various embodiments of the present disclosure.

FIG. 2D is an exemplary side view of the seat suspension system shown in FIG. 2A, wherein a portion of the chassis has been removed to more clearly illustrate the seat suspension system, and wherein seat suspension system is configured in the compressed disposition, in accordance with various embodiments of the present disclosure.

FIG. 2E is an exemplary isometric rear view of the seat suspension system shown in FIG. 2B, and wherein seat suspension system is configured in the neutral disposition, in accordance with various embodiments of the present disclosure.

FIG. 2F is an exemplary side view of a rocker assembly of the seat suspension system, in accordance with various embodiments of the present disclosure.

FIG. 3A is an exemplary exploded view of the seat suspension system shown in FIGS. 1A and 1B, in accordance with various embodiments of the present disclosure.

FIG. 3B is an exemplary side view of the seat suspension system shown in FIG. 3A mounted to a lightweight vehicle chassis and having a seat attached thereto, wherein seat suspension system is configured in a neutral disposition, in accordance with various embodiments of the present disclosure.

FIG. 3C is an exemplary side view of the seat suspension system shown in FIG. 3A, wherein a portion of the chassis has been removed to more clearly illustrate the seat suspension system, and wherein seat suspension system is configured in the neutral disposition, in accordance with various embodiments of the present disclosure.

FIG. 3D is an exemplary side view of the seat suspension system shown in FIG. 3A, wherein a portion of the chassis has been removed to more clearly illustrate the seat suspension system, and wherein seat suspension system is configured in a compressed disposition, in accordance with various embodiments of the present disclosure.

FIG. 3E is an exemplary isometric rear view of the seat suspension system shown in FIG. 3B, and wherein seat suspension system is configured in the neutral disposition, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

As used herein, the word “forward” and the phrase “forward of” are used to describe the direction from a named component or structure toward the front of the vehicle described and illustrated herein. Similarly, as used herein, the word “rearward” and the phrase “rearward of” are used to describe the direction from a named component or structure toward the rear of the vehicle described and illustrated herein.

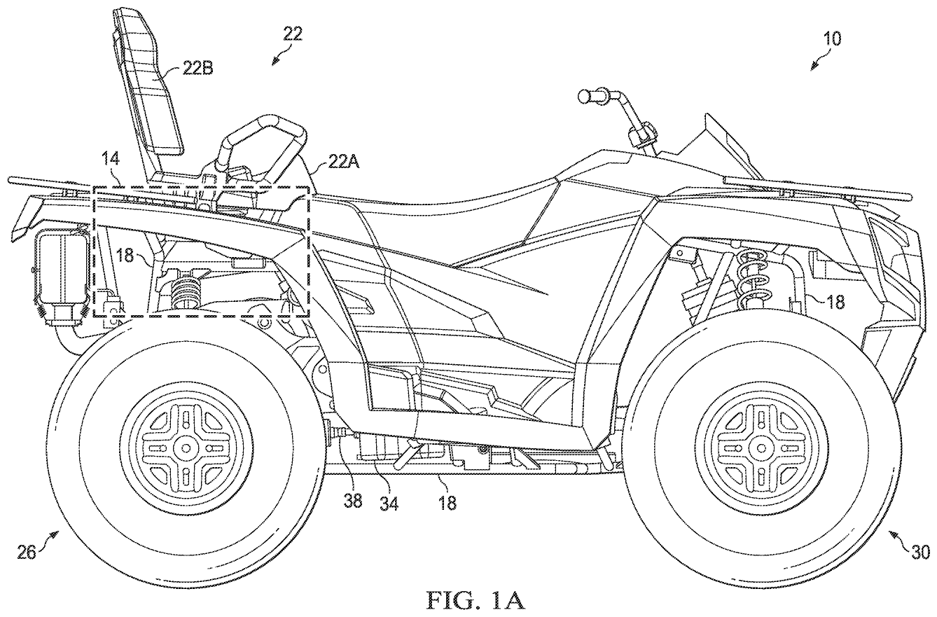

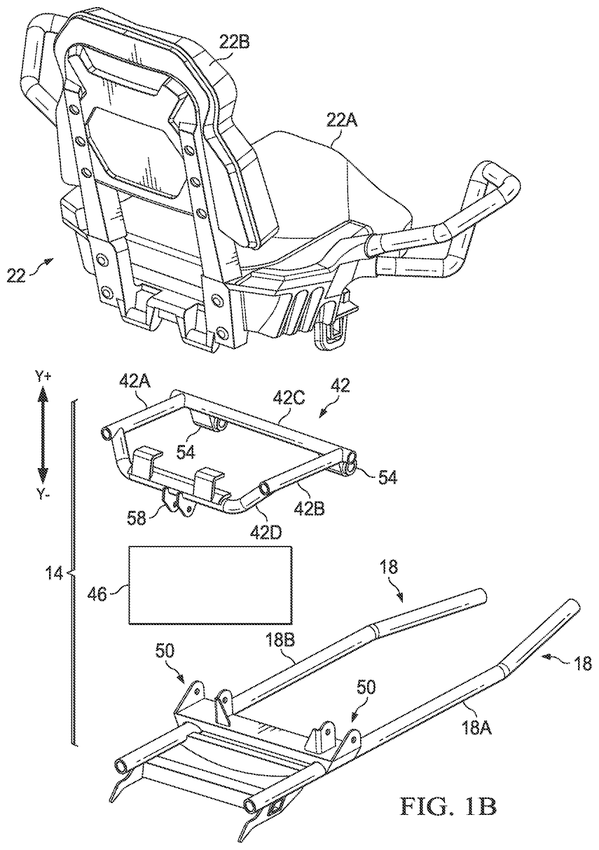

Referring to FIG. 1A and 1B, in various embodiments, the present disclosure provides a lightweight vehicle 10 that comprises a seat suspension system 14 structured and operable to dampen, soften, absorb, reduce and/or minimize the transfer of movement, vibration and/or shock from a chassis or frame 18 of the vehicle 10 to a seat 22 of the vehicle 10. The seat suspension system 14 is applicable for use with any lightweight vehicle seat generally having at least a bottom 22A, and in various instances a back 22B. For example, the seat suspension system 14 is applicable to a driver's seat, a passenger's seat, a front seat and/or a rear seat of any lightweight vehicle 10. The lightweight vehicle 10 can be any suitable lightweight vehicle such as any power sports vehicle, off-road vehicle and other lightweight vehicles including, but not limited to, snowmobiles, watercraft, all-terrain vehicles (ATVs), utility task vehicles (UTVs), recreational offhighway vehicles (ROVs), side-by-side vehicles (SSV), worksite vehicles, cargo vehicles, shuttle vehicles, buggies, motorcycles, tactical vehicles, golf cars, personal transport vehicles, worksite vehicles, airport ground support vehicles, factory and warehouse vehicles, turf maintenance vehicles, etc. (hereafter referred to as the vehicle 10). For simplicity and clarity, the vehicle 10 will be exemplarily described and illustrated is an ATV and the seat suspension system 14 will be exemplarily described and illustrated with regard to a rear seat of the vehicle 10.

The vehicle 10 generally includes the chassis 18, a pair of rear wheels 26 and a pair of front wheels 30 operationally connected to the chassis 18, and a prime mover 34 operatively connected to a drivetrain 38 that is operatively connected to at least one of the rear and/or front wheels 26 and/or 30. The prime mover 34 can be any motor, engine of torque generating device that is structured and operable to generate torque (e.g., motive force, e.g., power) utilized to provide motive force for the vehicle 10 via the drivetrain 38. For example, in various embodiments, the prime mover 34 can be an internal combustion engine (ICE), an electric motor, a hybrid combination of an ICE and an electric motor, or any other suitable motive power source and remain within the scope of the present disclosure.

Referring particularly to FIG. 1B, the seat suspension system 14 generally includes a seat frame 42 to which the seat 22 can be connected (removably connected in various instances), and a damping device assembly 46 generically shown in block illustration form in FIG. 1B. The seat frame 42 comprises a first siderail 42A, an opposing second siderail 42B, a front cross member 42C extending between the first and second siderails 42A and 42B, a rear cross member 42D extending between the first and second siderails 42A and 42B. The seat suspension system 14 additionally includes one or more (e.g., a pair of) seat frame mounting bracket(s) 50 mounted to or integrally formed with and extending from the vehicle chassis 18, one or more (e.g., a pair of) mounting feet 54 mounted to or integrally formed with and extending from the front cross member 42C (or alternatively from the first and second siderails 42A and 42B), and a damping assembly mounting bracket 58 mounted to or integrally formed with and extending from the rear cross member 42D. The mounting foot/feet 54 is/are pivotally connectable to the seat frame mounting brackets 58 via any suitable fastener such as a nut and bolt assembly, a pin and cotter pin assembly, etc., such that the front portion of the seat frame 42, e.g., the front cross member 42C, is pivotally connected to the vehicle chassis 18 and the seat rear cross member can move up and down in the Y+ and the Y− directions. The damping device assembly 46 is generally mounted to and interoperable (directly or indirectly) between the vehicle chassis 18 and the damping assembly mounting bracket 58. The damping device assembly 46 is structured and operable to dampen, soften, absorb, reduce and/or minimize the transfer of movement, vibration and/or shock from the vehicle chassis 18 to the seat frame 42, and more particularly to a person sitting in the seat 22 connected to the seat frame 42 as the vehicle traverses rough, bumpy, undulating, uneven or otherwise rugged terrain.

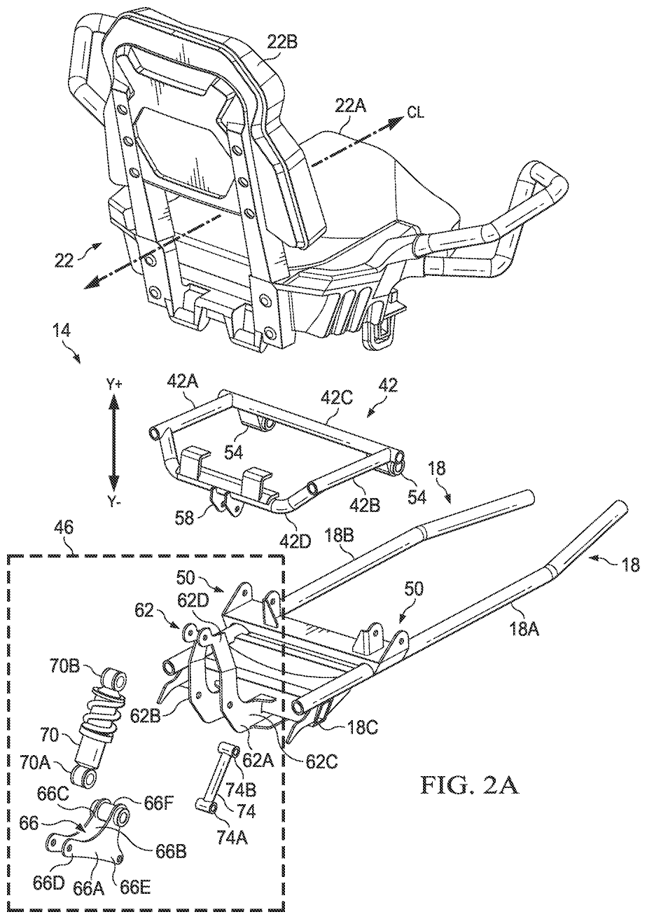

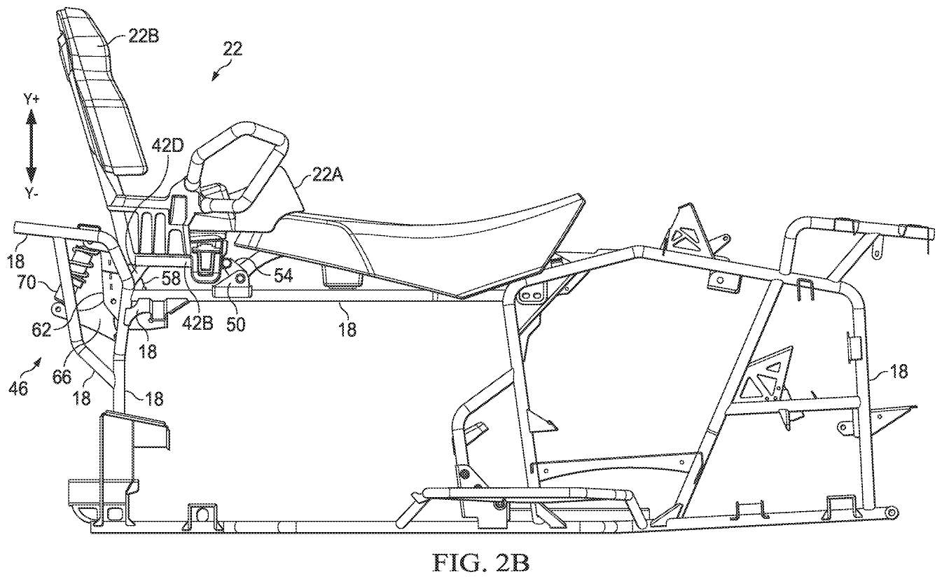

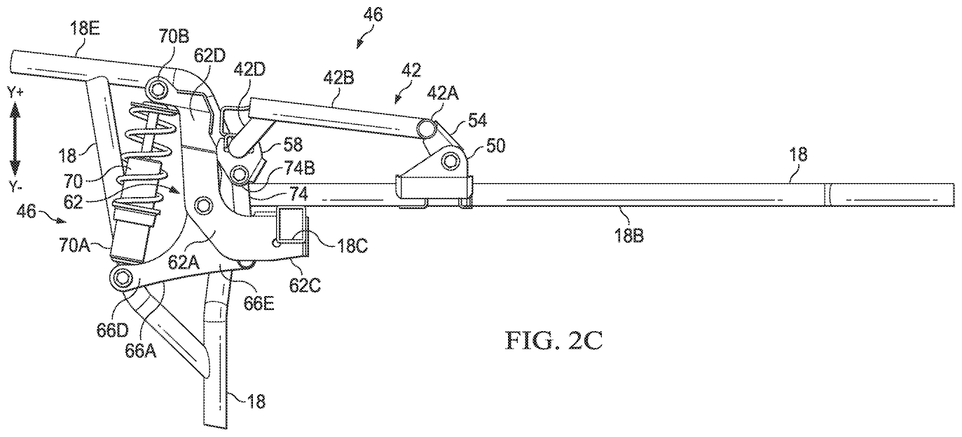

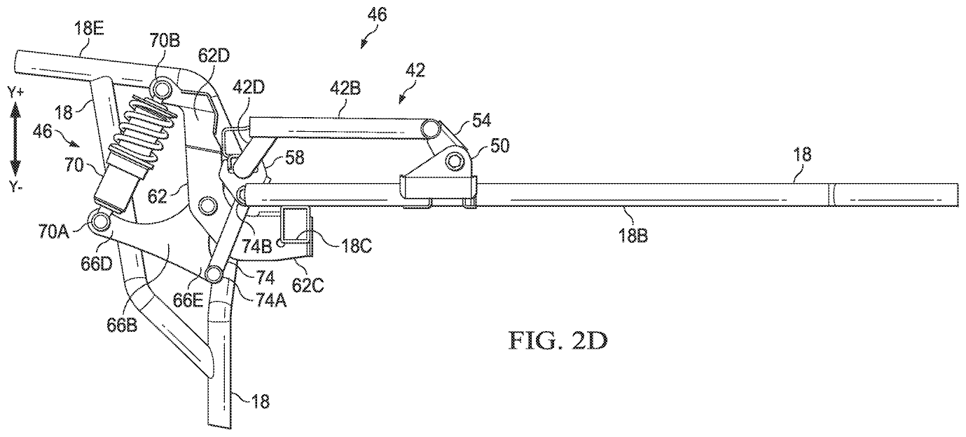

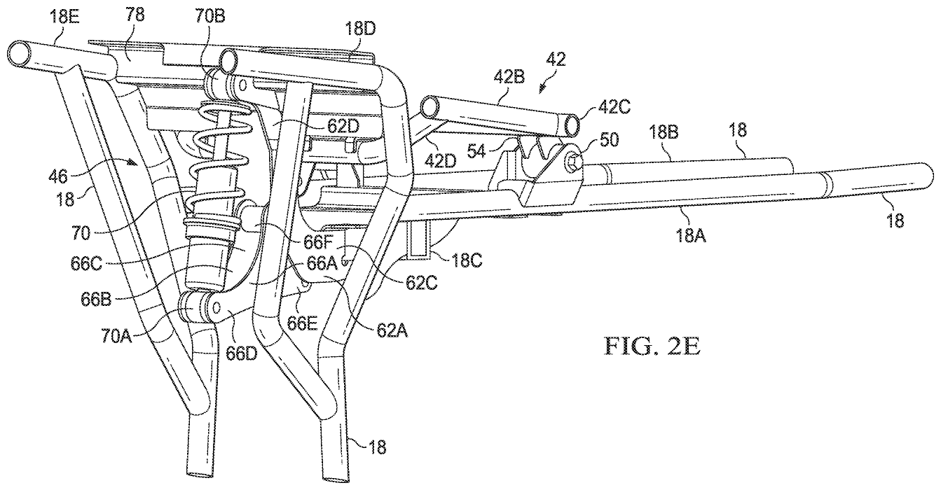

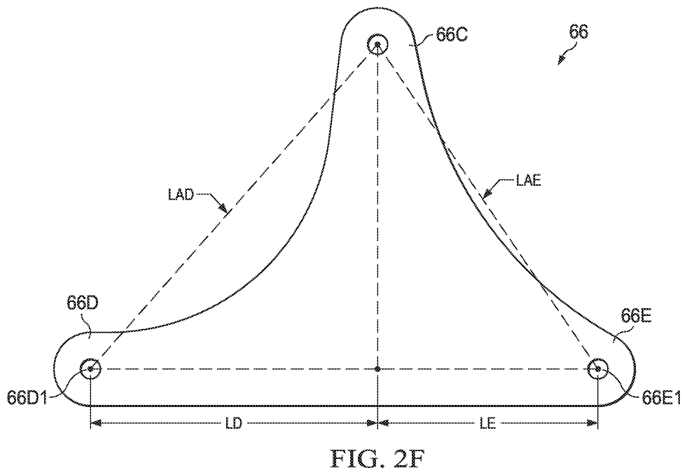

Referring now to FIGS. 1, 2A, 2B, 2C, 2D and 2E, in various embodiments the damping device assembly 46 is generally disposed rearward of the seat frame 42 and below a rearward portion of the seat frame 42. In such embodiments, the damping device assembly 46 comprises a support backbone 62, a rocker assembly 66, a damping device 70 and a push rod 74. The support backbone 62 is mounted to the vehicle chassis 18 via any suitable manner, e.g., via fastening using screws, nuts and bolts, or rivets, or via welding, etc. In various embodiments, the support backbone 62 can be mounted to the vehicle chassis such that the support backbone 62 is disposed adjacent the seat frame rear cross member 42D (e.g., below and rearward of the rear cross member 42D) and is generally aligned with and/or is colinear with a longitudinal center line CL of the seat 22 between opposing chassis top outer rails 18A and 18B (FIG. 2A). The support backbone 62 can have any shape and size suitable to provide the structure and functionality described herein. For example, in various embodiments the support backbone 62 can be generally L-shaped and comprise two side plates 62A and 62B that form a lower leg 62C and an upper leg 62D. Alternatively, it is envisioned that in various embodiments the support backbone 62 can comprise a single plate comprising the lower and upper legs 62C and 62C and remain within the scope of the present disclosure. In various instances the lower leg 62C can be connected to (e.g., fastened to or welded to) a chassis crossbar 18C extending between the opposing top rails 18A and 18B, and the upper leg 62D can be connected to (e.g., fastened to or welded to) a crossbeam 78 disposed between and connected to (e.g., fastened to or welded to) opposing chassis luggage rack arms 18D and 18E (FIG. 2E).

In various embodiments, the rocker assembly 66 comprises two opposing generally triangular shaped side plates 66A and 66B that form a neck 66C, a damping device arm 66D and a push rod arm 66E of the rocker assembly 66. The damping device arm 66D extends in a first direction from the neck 66C, and the push rod arm 66E extends in a second direction from the neck 66C. In various embodiments, the side plates 66A and 66B are joined at a distal end of the neck 66C by a cylindrical bearing 66F that is structured and operable to pivotally mount the rocker assembly neck 66C between the side plates 62A and 62B of the support back bone upper leg 62D. Although the rocker assembly 66 is exemplarily described to comprise the two opposing generally triangular shaped side plates 66A and 66B, it is envisioned that in various embodiments the rocker assembly 66 can comprise a single plate comprising the neck 66C, the damping device arm 66D and the push rod arm 66E and remain within the scope of the present disclosure.

The damping device 70 can be any device structured and operable to controllably, resistively and resiliently compress and extend (e.g., jounce and rebound) in response to the impact forces, shock and vibration encountered by the vehicle 10 and chassis 18 as the vehicle 10 traverses rough, bumpy, undulating, uneven or otherwise rugged terrain, thereby absorbing or damping the transferred of such impact forces, shock and vibration to the seat 22. For example, in various embodiments the damping device 70 can be a pistonbased shock absorber as exemplarily illustrated in the various figures. The damping device 70 is pivotally connected at first end 70A to the rocker plate damping device arm 66D and pivotally connected at a second end 70B to the support backbone upper leg 62D. The push rod 74 is a stiff rigid rod, strap, bar or pole that is structured and operable to pivotally connect at a first end 74A to the rocker plate push linkage arm and pivotally connected at a second end 74B to the damping assembly mounting bracket 58 of the seat frame 42.

As one skilled in art will readily understand, when a passenger is sitting in the seat 22, the weight of the passenger will exert a downward force in the Y⁻ direction on the seat frame rear cross member 42D, which will in turn exert a downward force in the Y⁻ direction on the push rod 74, which will in turn exert a downward force in the Y⁻ direction on the rocker assembly push rod arm 66E. Since the rocker assembly neck 66C is pivotally connected to the support backbone 62, the downward force in the Y⁻ direction of the push rod arm 66E will cause the push rod arm 66E to move in the Y⁻ direction, which will cause the rocker assembly damping device arm 66D to move in the Y⁺ direction, thereby exerting an upward or compressive force in the Y⁺ direction on the damping device 70 causing the damping device 70 to compress. The damping device 70 can be selected to have any desired strength of resistance to compression, or damping force, such that weight of passenger within a specified weight range will only compress the damping device 70 an amount that will leave the damping device 70 with a specified stroke length when a passenger is seated in the seat 22. Stroke length will be understood to mean the difference in overall length of the damping device between a fully compressed state and a fully extended state. The damping device 70 will be understood to be in a neutral disposition, as exemplarily shown in FIG. 2C, when a passenger is seated in the seat 22 and the vehicle 10 is stationary or traversing relatively flat smooth terrain whereby the chassis 18 will experience minimal movement in the Y⁺ and Y⁻ directions and the Y⁺ and Y⁻ forces transferred from the chassis 18 and support backbone 62 to the damping device 70 are minimal. The damping device 70 can be selected to have any desired operating compression and expansion resistive force, e.g., shock strength, such that the damping device 70 maintains the seat 22 in a particular position when the damping device 70 is in the neutral disposition.

In operation, when the vehicle 10 traverses rough, bumpy, undulating, uneven or otherwise rugged terrain the impact forces, shock and vibration encountered by the vehicle 10 are transferred to the vehicle chassis 18. However, due to the interconnection of the seat 22 to the chassis 18 via the damping device assembly 46, the impact forces, shock and vibration encountered by the chassis 18 are not transferred directly to the seat 22, particularly not to a passenger sitting the seat 22. More particularly, the disposition, interconnection and interoperability of the damping device assembly 46 between the chassis 18 and the seat 22 allow chassis 18 to move relative to the seat 22, particularly relative to the seat frame rear cross member 42D, thereby damping the transfer of the impact forces, shock and vibration to the seat 22, particularly to the seat frame rear cross member 42D, and more particularly to a passenger sitting in the seat 22. Furthermore, since the support back bone 62 of the damping device assembly 46 is mounted directly to the chassis 18, when the chassis 18 experiences impact forces, shock and vibration the impact forces, shock and vibration are transferred directly to the support backbone 62. As described above, the seat frame rear cross member 42D is interoperably connected to the support backbone via the push rod 74, the rocker assembly 66 and the damping device 70. As also described above, the damping device 70 is structured and operable to controllably, resistively and resiliently compress and extend (e.g., jounce and rebound) in response to the impact forces, shock and vibration encountered by the vehicle 10 and chassis 18, thereby absorbing or damping the transfer of such impact forces, shock and vibration to the seat frame rear cross member 42D and the seat 22. Hence, the damping device assembly is structured and operable to allow the chassis 18 to move relative to the seat frame rear cross member 42D and the seat 22 and dampen impact forces, shock and vibration transferred therebetween.

Specifically, when a force is exerted on the chassis 18 and support backbone 62 in the Y⁺ direction a counter force in the Y⁻ direction is exerted on the seat frame rear cross member 42D due to the weight of the passenger seated in the seat 22. This opposition of forces causes the seat frame rear cross member 42D to force the push rod downward in the Y⁻ direction, which in turn applies force to the rocker assembly push rod arm 66E generally in the Y⁻ causing the rocker assembly 66 to pivot about an axis of the cylindrical bearing 66F at the connection of the neck 66C to the support backbone 62. The pivoting of the rocker assembly 66 about the axis of the cylindrical bearing 66F causes the rocker assembly damping device arm 66D to apply force to the damping device generally in the Y⁺ direction causing the damping device 70 to compress and thereby absorb or dampen the translation of force applied to the damping device generally in the Y⁺ direction to the seat frame rear cross member 42D, and hence to a passenger seated in the seat 22.

Referring now to FIG. 2F, as one skilled in the art will readily recognize and understand, a length LD of the rocker assembly damping device arm 66D relative to a length LE of the rocker assembly push rod arm 66E will dictate the distance the respect distal end ends 66D1 and 66E1 will travel in the general Y⁺ and Y⁻ directions. Moreover, the damping device arm length LD and the push rod arm length LE will determine a stroke length of the biasing device 70 (e.g., the difference in length between full extension and full compression of the biasing device 70) and a travel distance of the seat frame rear cross member 42D (e.g., the maximum distance the seat frame rear cross member 42D will travel in the Y⁺ and Y⁻ directions). Additionally, it follows then that the length LD of the rocker assembly damping device arm 66D relative to the length LE of the rocker assembly push rod arm 66E will dictate the amount of force in the general Y⁺ direction delivered to the damping device 70 by the damping device arm 66D relative to the amount of force in the general Y⁻ direction delivered to the push rod arm 66E by the push rod 74. More specifically, the length LD of the damping device arm 66D will determine the length of a lever arm LAD of the damping device arm 66D and the length LE of the push rod arm 66E will determine the length of a lever arm LAE of the push rod arm 66E.

One skilled in the art will readily recognize and understand that the length of the push rod arm lever arm LAE relative to the length of the damping device arm lever arm LAD will dictate the distance of movement in the general Y⁺ direction by, and the amount of force in the general Y⁺ direction delivered to, the damping device 70 by the damping device arm 66D relative to the distance of movement in the general Y⁻ direction by, and the amount of force in the general Y⁻ direction delivered to, the push rod arm 66E by the push rod 74. Furthermore, the length of the push rod arm lever arm LAE relative to the length of the damping device arm lever arm LAD dictate a motion ratio between the push rod arm distal end 66E1 and the damping device arm distal end 66D1. Accordingly, it is envisioned that in various embodiments the shape, size and geometry of the rocker assembly 66, particularly the length of the lengths LD and LE of the damping device arm 66D and the push rod arm 66E, and hence the lengths of the damping device arm lever arm LAD and the push rod arm lever arm LAE can be chosen to dictate and control a desired amount of stroke length of the damping device 70, a desired motion ratio between the push rod arm distal end 66E1 and the damping device arm distal end 66D1, and an amount of force translated from the vehicle chassis 18 to the seat frame rear cross member 42D. Additionally, as described above, the damping device 70 can be selected to have any desired operating compression and expansion resistive force, e.g., shock strength, that will further dictate and control a desired amount of stroke length of the damping device 70, and control an amount of force translated from the vehicle chassis 18 to the seat frame rear cross member 42D.

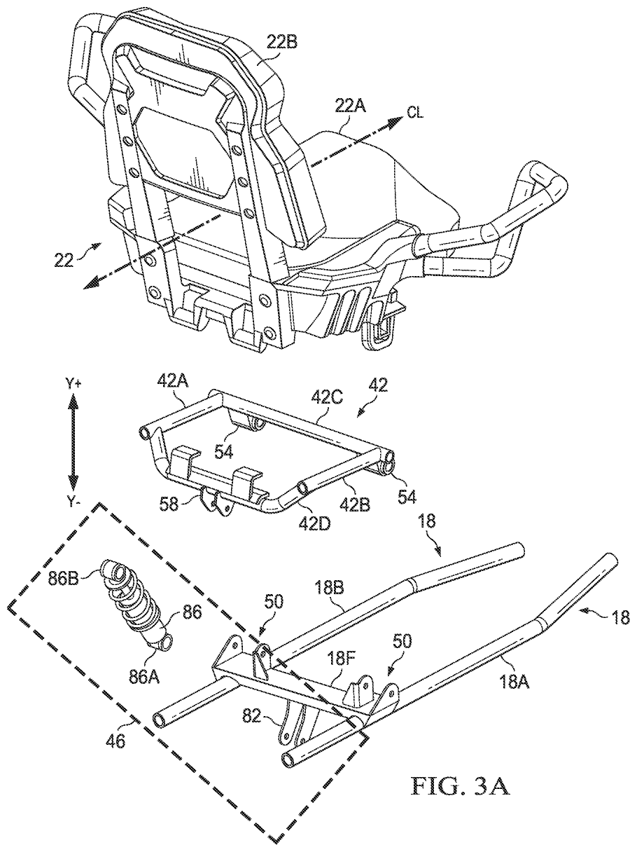

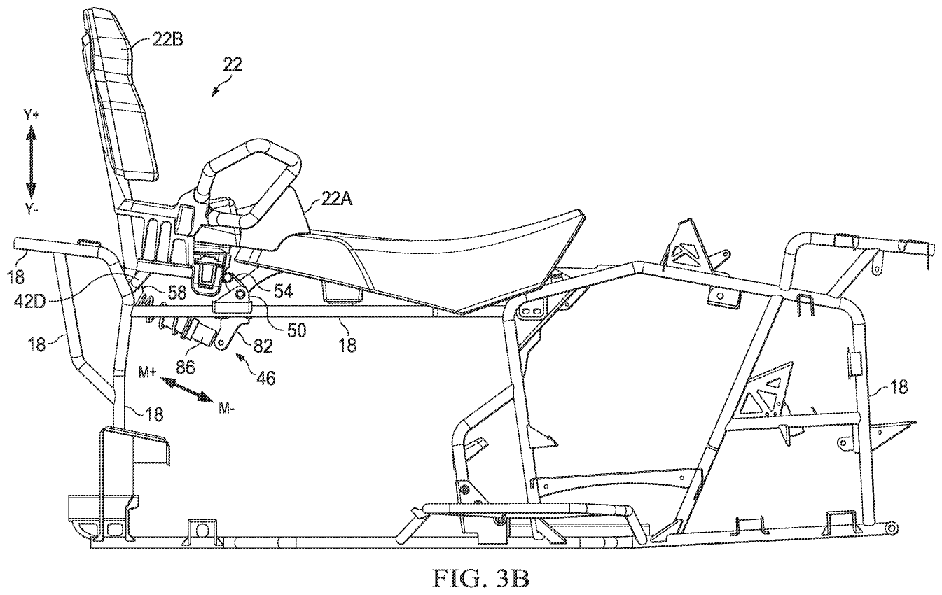

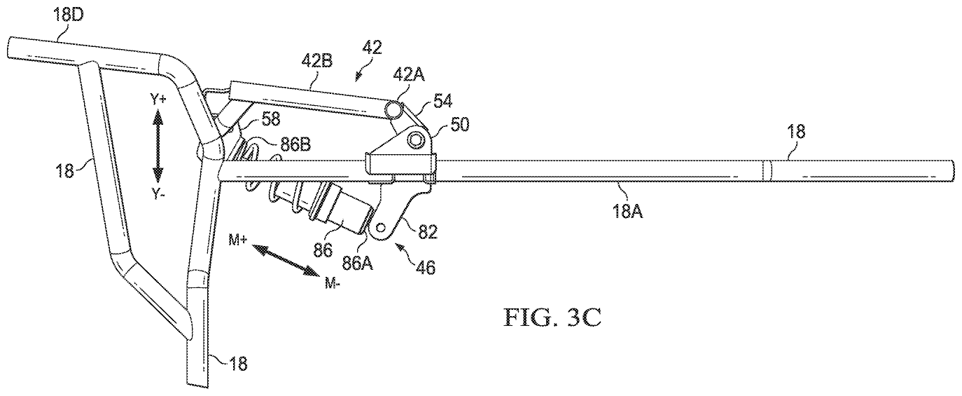

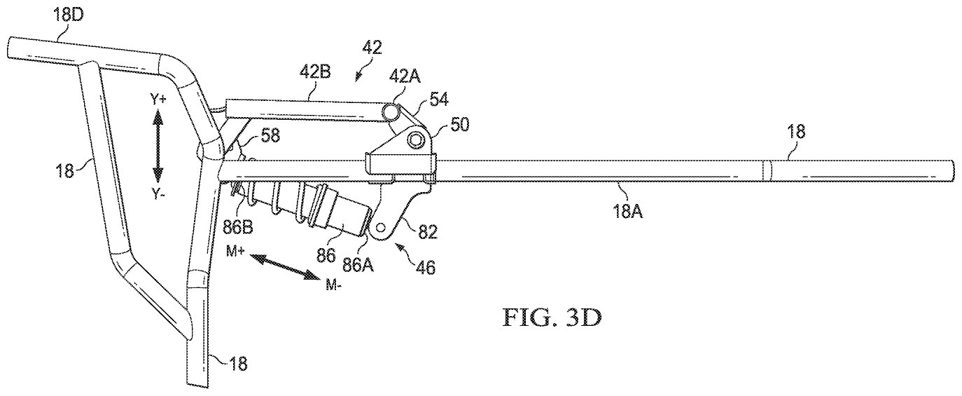

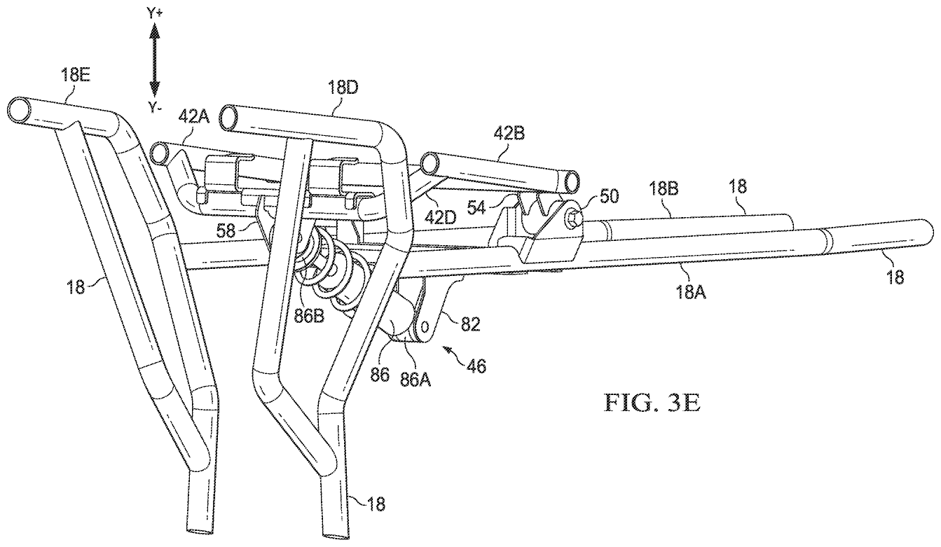

Referring now to FIGS. 3A, 3B, 3C, 3D and 3E, in various embodiments, the damping device assembly 46 can be generally disposed beneath the seat frame 42. In such embodiments, the damping device assembly 46 comprises a damping device mounting member 82 and a damping device 86. The damping device mounting member 82 is mounted to a chassis cross brace 18F mounted between the chassis top outer rails 18A and 18B and adjacent to, in close proximity to and/or contacting the seat frame mounting bracket(s) 50. Furthermore, the damping device mounting member 82 extends downward from the chassis cross brace 18F and is disposed directly beneath the seat frame front cross member 42C and is generally aligned with the longitudinal center line CL of the seat 22 (FIG. 3A). The damping device 86 is pivotally connected at a first end 86A to the damping device mounting member 82, and pivotally connected at a second end 86B to the damping assembly mounting bracket 58 such that the damping device 86 is disposed under the seat frame 42 and extends from the damping device mounting member 82 directly beneath the seat frame front cross member 42C rearward to the damping assembly mounting bracket 58 mounted to the seat frame rear cross member 42D. Additionally, the damping device 86 is mounted between the damping device mounting member 82 and the damping assembly mounting bracket 58 such that the damping device 86 is generally aligned with and/or colinearly with the longitudinal center line CL of the seat 22.

As described above with regard to damping device 70, the damping device 86 can be any device structured and operable to controllably, resistively and resiliently compress and extend (e.g., jounce and rebound) in response to the impact forces, shock and vibration encountered by the vehicle 10 and chassis 18 as the vehicle 10 traverses rough, bumpy, undulating, uneven or otherwise rugged terrain, thereby absorbing or damping the transferred of such impact forces, shock and vibration to the seat 22. For example, in various embodiments the damping device 86 can be a piston-based shock absorber as exemplarily illustrated in the various figures. The damping device 86 is pivotally connected at the first end 86A to the damping device mounting member 82 disposed beneath the seat frame front cross member 42C and pivotally connected at the damping assembly mounting bracket connected to the seat frame rear cross member 42D.

As one skilled in art will readily understand, when a passenger is sitting in the seat 22, the weight of the passenger will exert a downward force in the Y⁻ direction on the seat frame rear cross member 42D, which will in turn exert a compressive force in the M direction on damping device 86 causing the damping device 86 to compress. The damping device 86 can be selected to have any desired strength of resistance to compression, or damping force, such that weight of passenger within a specified weight range will only compress the damping device 86 an amount that will leave the damping device 86 with a specified stroke length when a passenger is seated in the seat 22. Stroke length will be understood to mean the difference in overall length of the damping device between a fully compressed state and a fully extended state. The damping device 86 will be understood to be in a neutral disposition, as exemplarily shown in FIG. 3C, when a passenger is seated in the seat 22 and the vehicle 10 is stationary or traversing relatively flat smooth terrain whereby the chassis 18 will experience minimal movement in the Y⁺ and Y⁻ directions and the Y⁺ and Y⁻ forces transferred from the chassis 18 to the damping device 86 are minimal. The damping device 86 can be selected to have any desired operating compression and expansion resistive force, e.g., shock strength, such that the damping device 86 maintains the seat 22 in a particular position when the damping device 86 is in the neutral disposition.

In operation, when the vehicle 10 traverses rough, bumpy, undulating, uneven or otherwise rugged terrain the impact forces, shock and vibration encountered by the vehicle 10 are transferred to the vehicle chassis 18. However, due to the interconnection of the seat 22 to the chassis 18 via the damping device assembly 46, the impact forces, shock and vibration encountered by the chassis 18 are not transferred directly to the seat 22, particularly not to a passenger sitting the seat 22. More particularly, the disposition, interconnection and interoperability of the damping device assembly 46 between the chassis 18 and the seat 22 allow chassis 18 to move relative to the seat 22, particularly relative to the seat frame rear cross member 42D, thereby damping the transfer of the impact forces, shock and vibration to the seat 22, particularly to the seat frame rear cross member 42D, and more particularly to a passenger sitting in the seat 22. Furthermore, since the damping device mounting member 82 of the damping device assembly 46 is mounted directly to the chassis 18 (i.e., the chassis cross brace 18F, when the chassis 18 experiences impact forces, shock and vibration the impact forces, shock and vibration are transferred directly to damping device mounting member 82. As described above, the damping device 86 is structured and operable to controllably, resistively and resiliently compress and extend (e.g., jounce and rebound) in response to the impact forces, shock and vibration encountered by the vehicle 10 and chassis 18, thereby absorbing or damping the transfer of such impact forces, shock and vibration to the seat frame rear cross member 42D and the seat 22. Hence, the damping device assembly 46 is structured and operable to allow the chassis 18 to move relative to the seat frame rear cross member 42D and the seat 22 and dampen impact forces, shock and vibration transferred therebetween.

Specifically, when a force is exerted on the chassis 18 and damping device mounting member 82 in the Y⁺ direction a counter force in the Y⁻ direction is exerted on the seat frame rear cross member 42D due to the weight of the passenger seated in the seat 22. This opposition of forces causes the seat frame rear cross member 42D to exert a compressive force on the damping device 86 in the M direction causing the damping device 86 to compress and thereby absorb or dampen the translation of force applied to the chassis 18 in the Y⁺ direction to the seat frame rear cross member 42D, and hence to a passenger seated in the seat 22. As described above, the damping device 86 can be selected to have any desired operating compression and expansion resistive force, e.g., shock strength, that will dictate and control a desired amount of stroke length of the damping device 86, and control an amount of force translated from the vehicle chassis 18 to the seat frame rear cross member 42D.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. A seat suspension system for a seat of a lightweight vehicle, said system comprising:
a seat frame to which a seat can be connected, the seat frame comprising
a first siderail;
a second siderail;
a front cross member extending between the first and second siderails; and
a rear cross member extending between the first and second siderails;
one or more of seat frame mounting bracket mounted to a chassis of the vehicle;
one or more mounting feet extending from a front portion of the seat frame, the one or more mounting feet pivotally connectable to the one or more seat frame mounting bracket; and
a damping assembly mounting bracket mounted to the rear cross member; and
a damping device assembly mounted between the chassis of the vehicle and the damping assembly mounting bracket, the damping device assembly structured and operable to dampen the transfer of movement from the chassis of the vehicle to the seat frame.

2. The system of claim 1, wherein the damping assembly comprises:
a support backbone mounted to the chassis of the vehicle;
a rocker assembly, the rocker assembly comprising;
a neck pivotally connected to the support backbone;
a damping device arm extending in a first direction from the neck; and
a push rod arm extending in a second direction from the neck;
a damping device pivotally connected at first end to the rocker assembly damping device arm, and pivotally connected at a second end to the support backbone; and
a push rod pivotally connected at a first end to the rocker assembly push rod arm and pivotally connected at a second end to the damping assembly mounting bracket of the seat frame.

3. The system of claim 2, wherein a length of the damping device arm is greater than a length of the push rod arm.

4. The system of claim 1, wherein the length of the damping device arm controls a stroke length of the damping device, and the length of the push rod arm control a travel distance of the rear cross member of the seat frame.

5. The system of claim 1, wherein the damping assembly comprises
a damping device mounting member mounted to a chassis cross brace disposed adjacent the one or more of seat frame mounting bracket and directly beneath the seat frame front cross member, the damping device mounting member extending downward from the chassis cross brace; and
a damping device pivotally connected at first end to the damping device mounting member, and pivotally connected at a second end to the damping assembly mounting bracket such that the damping device is disposed under the seat frame and extends from the damping device mounting member directly beneath the seat frame front cross member rearward to the damping assembly mounting bracket mounted to the seat frame rear cross member.

6. A seat assembly for a lightweight vehicle, said assembly comprising:
a seat frame to which a seat can be connected, the seat frame comprising a first siderail;
a second siderail;
a front cross member extending between the first and second siderails; and
a rear cross member extending between the first and second siderails;
one or more of seat frame mounting bracket mounted to a chassis of the vehicle;
one or more mounting feet extending from a front portion of the seat frame, the one or more mounting feet pivotally connectable to the one or more seat frame mounting bracket; and
a damping assembly mounting bracket mounted to the rear cross member;
a seat connectable to the seat frame; and
a damping assembly mounted between the chassis of the vehicle and the damping assembly mounting bracket, the damping device assembly structured and operable to dampen the transfer of movement from the chassis of the vehicle to the seat.

7. The assembly of claim 6, wherein the damping assembly comprises:
a support backbone mounted to the chassis of the vehicle;
a rocker assembly, the rocker assembly comprising;
a neck pivotally connected to the support backbone;
a damping device arm extending in a first direction from the neck; and
a push rod arm extending in a second direction from the neck;
a damping device pivotally connected at first end to the rocker assembly damping device arm, and pivotally connected at a second end to the support backbone; and
a push rod pivotally connected at a first end to the rocker assembly push rod arm and pivotally connected at a second end to the damping assembly mounting bracket of the seat frame.

8. The assembly of claim 7, wherein a length of the damping device arm is greater than a length of the push rod arm.

9. The assembly of claim 6, wherein the length of the damping device arm controls a stroke length of the damping device, and the length of the push rod arm control a travel distance of the rear cross member of the seat frame.

10. The assembly of claim 6, wherein the damping assembly comprises
a damping device mounting member mounted to a chassis cross brace disposed adjacent the one or more of seat frame mounting bracket and directly beneath the seat frame front cross member, the damping device mounting member extending downward from the chassis cross brace; and
a damping device pivotally connected at first end to the damping device mounting member, and pivotally connected at a second end to the damping assembly mounting bracket such that the damping device is disposed under the seat frame and extends from the damping device mounting member directly beneath the seat frame front cross member rearward to the damping assembly mounting bracket mounted to the seat frame rear cross member.

11. A lightweight vehicle, said vehicle comprising:
a chassis; and
a seat assembly, the assembly comprising:
a seat frame to which a seat can be connected, the seat frame comprising
a first siderail;
a second siderail;
a front cross member extending between the first and second siderails; and
a rear cross member extending between the first and second siderails;
one or more of seat frame mounting bracket mounted to a chassis of the vehicle;
one or more mounting feet extending from a front portion of the seat frame, the one or more mounting feet pivotally connectable to the one or more seat frame mounting bracket; and
a damping assembly mounting bracket mounted to the rear cross member;
a seat connectable to the seat frame; and
a damping assembly mounted between the chassis of the vehicle and the damping assembly mounting bracket, the damping device assembly structured and operable to dampen the transfer of movement from the chassis of the vehicle to the seat.

12. The vehicle of claim 11, wherein the damping assembly comprises:
a support backbone mounted to the chassis of the vehicle;
a rocker assembly, the rocker assembly comprising;
a neck pivotally connected to the support backbone;
a damping device arm extending in a first direction from the neck; and
a push rod arm extending in a second direction from the neck;
a damping device pivotally connected at first end to the rocker assembly damping device arm, and pivotally connected at a second end to the support backbone; and
a push rod pivotally connected at a first end to the rocker assembly push rod arm and pivotally connected at a second end to the damping assembly mounting bracket of the seat frame.

13. The vehicle of claim 12, wherein a length of the damping device arm is greater than a length of the push rod arm.

14. The vehicle of claim 11, wherein the length of the damping device arm controls a stroke length of the damping device, and the length of the push rod arm control a travel distance of the rear cross member of the seat frame.

15. The assembly of claim 11, wherein the damping assembly comprises
a damping device mounting member mounted to a chassis cross brace disposed adjacent the one or more of seat frame mounting bracket and directly beneath the seat frame front cross member, the damping device mounting member extending downward from the chassis cross brace; and
a damping device pivotally connected at first end to the damping device mounting member, and pivotally connected at a second end to the damping assembly mounting bracket such that the damping device is disposed under the seat frame and extends from the damping device mounting member directly beneath the seat frame front cross member rearward to the damping assembly mounting bracket mounted to the seat frame rear cross member.
